(19) United States
(12) Patent Application Publication
(10) Pub. No.: US 2009/0010737 A1
(43) Pub. Date: Jan. 8, 2009

(54) Integrated hard cover production method and device

(75) Inventors: Chou-Cheng Li, Hsin-Chuang (TW); Ming-Nan Huang, Hsin-Chuang (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(73) Assignee: Ren Thang Co., Ltd

(21) Appl. No.: 11/822,324

(22) Filed: Jul. 5, 2007

(51) Int. Cl. B42C 11/04

(52) U.S. Cl. 412/4

(57) ABSTRACT

An integrated hardcover production method and device comprising: a moving belt 1 installed inside a frame 10 horizontally moves a plurality of sheets 5 from a first end to a second end thereof; a stop plate 2 installed to a second end of the moving belt 1 aligns a spine 51 of the plurality of sheets 5; a set of forming rollers 22 installed along a first side of the stop plate 2 gradually convex inward; a translating device 3 moves transversely on the stop plate 2 inside the frame 10 to and fro, thereby the plurality of sheets 5 gripped by the translating device 3, the spine 51 flattened by passing through the forming rollers 22.

### FIELD OF THE INVENTION

The present invention relates to an integrated hard cover production method and device.

### DESCRIPTION OF PRIOR ARTS

Booklets, weekly, monthly, magazines, catalogues contain no more than twenty pages may be stapled along an axis between the cover and the back by saddle-wires similar to staples. After being stapled, printed matters are mainly divided into cover and back contain each half of contents, when closed, take a top or bottom view the cover and the back outstand likely two sides of an overall isosceles triangle arched slightly further being converged into an apex, where the saddle-wires located along the axis. A hardness of the cover and the back is only sufficient to support a division of the back, the cover, and a curvature of a spine (i.e. folded back portion) in between. Aesthetical senses in styles, layouts, as well as compositions of most printed materials are therefore doomed creator-oriented, but not user-oriented.

Person skilled in the arts has provided ways to produce a flattening of the curvature of the spine, such as U.S. Pat. No. 6,692,208 entitled “Method and apparatus for producing booklets” to Christopher Robin Watkins et al. on Feb. 17, 2004. It disclosed that a retractable stop plate 14 limits the downward movement of a plurality of sheets firmly gripped between a left and a right clamping jaws, especially, a spine of the sheets is in contact with the stop plate. To flatten a curvature of the spine, the stop plate retracts in a reverse direction; a forming roller passes one or more times along the spine with sufficient pressure. Thereby, the curvature of the spine turned into a flattening.

In U.S. Pat. No. 6,692,208, for example, clamping jaws 12 may be provided with ribs 16 to improve the grip. Ribs even have crease into a smooth surface. However, ribs should be distant from an upper surface of the stop plate 5˜10 mm. But the set of folded sheets 10 protrudes below the jaws may be accepted only within a range of 0.5˜1.75 mm.

Accordingly, the set of folded sheets 10 is gripped firmly about the ribs, where the folded sheets are not to be deformed, since the ribs limited their movements. While the roller 18 in contact with the protrusion exerts an upward pressure to the 0.5˜1.75 mm protrusion. It is, the folded sheets may be deformed from, at least, in the range of 1.75 to 5 mm between the protrusion and the ribs (i.e. between roller to ribs). Under such circumstance, booklet less than twenty pages may need the roller to roll over once for all, but more pages may need the roller rolls over to and fro twice, thrice to press down “pillow” between the cover and back. It may be a laborious and time-consuming workload.

Since the folded sheets are not limited to a definite volume, therefore, the ribs should be adjustable. Otherwise, when the roller exerts pressure, the gripped folded sheets may be displaced.

Under such circumstance, only one forming roller rolls over and presses down “pillows” for a longer while may induce damages to axle etc., or cause cracks happened to related components.

### SUMMARY OF THE INVENTION

Point against aforesaid problems, the present invention is to provide an integrated hardcover production method and device to flatten a spine (i.e. folded back portion) once for all, not only to save time, but also to streamline process of a flattening.

An integrated hardcover production method and device comprising steps: 1. a moving belt 1 feeds a stop plate 2 with a plurality of sheets 5; 2. the stop plate 2 simultaneously stops and aligns a spine 51 of the plurality of sheets 5; 3. a translating device 3 grips the plurality of sheets firmly and moves the plurality of sheets transversely to a right side; 4. the spine 51 of the plurality of sheets 5 passes through a set of forming rollers 22 obliquely arranged along a front side of the stop plate 2; the forming rollers roll over and flatten the spine 51 once for all; 5. the plurality of sheets 5 are released from the translating device 3.

An integrated hardcover production method and device comprising: a moving belt 1 installed inside a frame 10 horizontally moves a plurality of sheets 5 from a first end (i.e. a front end) to a second end (i.e. a rear end) thereof; a stop plate 2 installed to the second end of the moving belt 1 simultaneously stops and aligns a spine 51 of the plurality of sheets 5; a set of forming rollers 22 are obliquely installed along a first side (i.e. a front side) of arrayed in an oblique direction from left to right and gradually convex outward (i.e. from the second end to the first end); a translating device 3 moves transversely along the stop plate 2 in the frame 10 to and fro, thereby the plurality of sheets 5 gripped by the translating device 3, the spine 51 flattened by passing through the set of forming rollers 22.

An integrated hardcover production method and device as mentioned above wherein the moving belt 1 contains a support plate 11 has a groove 111, an upper moving belt 12 and a lower moving belt 13 mounted above/below the groove 111 in pair, where the upper belt 12 is corresponding to the lower belt 13; axles 120,130 of the moving belts 12,13 have driven gears 121,131 engaged with each other at left ends of the axles 120,130, a motor 14 fixed to a left side plate of the frame 10 has a gear 141 drives the gears 121,131 to rotate, whereby the upper/lower moving belts 12,13 move horizontally the plurality of sheets 5 inward (i.e. from the front end to the second end), axles 125,135 of the moving belts 12,13 drive a lever 15 to elevate/descend by a motor 16 fixed to the left side plate of the frame 10, thereby the plurality of sheets 5 can be gripped or released.

An integrated hardcover production method and device as mentioned above wherein an eccentric block 161 of the motor 16 drives the lever 15 moving reciprocally to elevate/descend along teeth bars 151,152 formed at top/bottom ends of the lever 15 to drive gears 123,133 rotating in clockwise/counterclockwise direction, the gears 123,133 installed at left ends of the axles 124, 134 respectively; the axle 124 coupled to a rocker 122, and the axle 134 coupled to a link 132 respectively, the rocker 122 and the link 132 drive the axles 125,135 of the upper/lower moving belts 12,13 to open/close the moving belt 1 simultaneously.

An integrated hardcover production method and device as mentioned above wherein a sensor 41 for sensing the plurality of sheets 5 input installed at a first end (i.e. a front end) of the support plate 11, a sensor 42 for sensing the plurality of sheets 5 output installed at a second end (i.e. a rear end) of the support plate 11, a sensor 43 for sensing the plurality of sheets 5 refills installed near a right side plate of the frame 10.

An integrated hardcover production method and device as mentioned above wherein the stop, plate 2 mainly consists of a glide slider 21, the forming rollers 22 contains rollers 221,222,223 arrayed side by side in order with slide out section slid outward from a first side of the glide slider 21; further two positioning rollers 224,225 retracted rearward related to the rollers 221˜223 projected out of a second side of the glide slider 21 to resist against a U-shaped stopper 36.

An integrated hardcover production method and device as mentioned above wherein a link 24 inserted in the glide slider 21, a number of stopping rollers 23 axially arrayed in alignment with one another along the link 24, each of the stopping rollers 23 has a slide out section a little slid outward from a space 211 of the glide slider 21, a left end of the link 24 extended out of the glide slider 21 is coupled to an eccentric wheel 241, which is coaxially coupled to a knob 242, which is rotated to activate the link 24 and to adjust a slide out section of the stopping rollers 23 slid outward from the space 211.

An integrated hardcover production method and device as mentioned above wherein the translating device 3 contains an upper sliding shaft 30 land a lower sliding shaft 302 transversely installed inside the frame 10 in parallel with each other, two side plates 31a,31b fit over the sliding shafts 301,302 formed with opened grooves 30 for passing through the stop plate 2 to and fro; a lower clamping jaw 32 installed between the side plates 31a,31b, two tappets 33a,33b installed outside the two side plates 31a,31b respectively, an upper clamping jaw 34 moved by the tappets 33a,33b moves upward and downward in coordination with the lower clamping jaw 32 to grip/release the plurality of sheets 5; and a worm 35 installed below the sliding shafts 301,302 is driven by a motor 351 to drive the side plates 31a,31b moving along the sliding shafts 301,302.

An integrated hardcover production method and device as mentioned above wherein the tappet 33a consists of a primary shaft 331 connected to the upper clamping jaw 34, a secondary shaft 332 inserted into the primary shaft 331, an expansion spring 333 loaded within the primary shaft 331 resists against the secondary shaft 332, and a movable plate 334 connected between the primary shaft 331 and the secondary shaft 332; a top end of the secondary shaft 332 is mounted in an eccentric to a gear 335, which is further connected to the tappet 33b by a sensor-equipped revolving shaft 337 (the sensor is designated a numeral 338), the tappet 33b has the same configuration as the tappet 33a has, the upper clamping jaw 34 moved by the tappets 33a, 33b can be displaced upward and downward to grip the plurality of sheets 5 in coordination with the lower clamping jaw 32, where the upper clamping jaw 34 is connected to the tappet 33a by a shaft 336, the plurality of sheets 5 is gripped between the upper/lower clamping jaws 34,32, the expansion spring 333 will be depressed further exerts a force, which is a derivation of an elastic force of the expansion spring 333 from depression, to grip the plurality of sheets firmly.

An integrated hardcover production method and device as mentioned above wherein each inner wall of the side plates 31a, 31b are equipped with two pairs of rollers are correspondingly in parallel with each other, thereby the upper clamping jaw 34 can be guided to elevate/descend through the rollers; lower portions of the side plates 31a, 31b have U-shaped grooves 312 to confine a vertical displacement of the shaft 336, which is connected between the upper clamping jaw 34 and the tappet 33a.

An integrated hardcover production method and device as mentioned above wherein a bottom end of the side plate 31a is extended out with a sensing kit 314 and a roller 313, the roller 313 is further extended to a guide groove 352 of the worm 35, a translating device 3 moves to and fro as the plurality of sheets 5 is gripped or released, each of two sensors 44,45 coupled to both ends of the worm 35 is activated by a signal respectively, in turn, the sensing kit 314 is triggered to stop a motor 37.

An integrated hardcover production method and device as mentioned above wherein the sensor 338 coupled to the revolving shaft 337 is activated, in turn, a sensor 46 coupled to the side plate 31b is triggered to limit the upper clamping jaw 34 moving upward and downward confined within a limited distance.

An integrated hardcover production method and device as mentioned above wherein an U-shaped stopper 36 transversely installed between the side plates 31a, 31b of the translating device 3, the U-shaped stopper 36 is corresponding to the position rollers 224,225 of the stop plate 2; further the U-shaped stopper 36 is in contact with both rollers 224,225.

An integrated hardcover production method and device as mentioned above wherein a top end of the bottom clamping jaw 32 has a front rib 322, a rear rib 321, a bottom end of the upper clamping jaw 34 has a front rib 342, a rear rib 341; the ribs 322,321 are corresponding to the ribs 342,341.

### BRIEF DESCRIPTION OF THE DRAWINGS

FIGS. 1˜4 show schematic views of movements of the invention;

FIG. 1A. shows a schematic view of rollers of a set of forming rollers obliquely arrayed in a line;

FIG. 3A. shows a schematic view of a spine is flattened;

FIG. 5. shows a schematic view of the invention in practice;

FIG. 6. shows a front view of the invention;

FIG. 7. shows a back view of the invention;

FIG. 8. shows a top-side view of an upper/a lower moving belts are close;

FIG. 9. shows a bottom-side view of FIG. 8;

FIG. 10. shows a top-side view of an upper/a lower moving belts are open;

FIG. 11. shows a bottom-side view of FIG. 10;

FIG. 12. shows a schematic view of sensors distribution in the invention;

FIG. 13. shows a schematic view of a glide slider of the invention;

FIG. 14. shows a cross sectional view of FIG. 13;

FIG. 15. shows a left side view of a translating device gripping a plurality of sheets;

FIG. 15A. shows a sectional view of the expansion spring is depressed, when the plurality of sheets gripped between the upper/lower clamping jaws;

FIG. 16. shows a right side view of FIG. 15;

FIG. 17. shows a schematic view of FIG. 16, where the plurality of sheets is released from the translating device;

FIG. 18. shows a schematic view of a spine of the plurality of sheets is rolled over and pressed down by a set of forming rollers;

FIG. 19. shows a schematic view of the plurality of sheets with less pages are gripped by an upper/a lower clamping jaws; and

FIG. 20. shows a schematic view of the plurality of sheets with more pages are gripped by the upper/lower clamping jaws.

### DETAILED DESCRIPTION OF THE PREFERRED EMBODIMENTS OF THE INVENTION

The description is described in detail according to the appended drawings hereinafter.

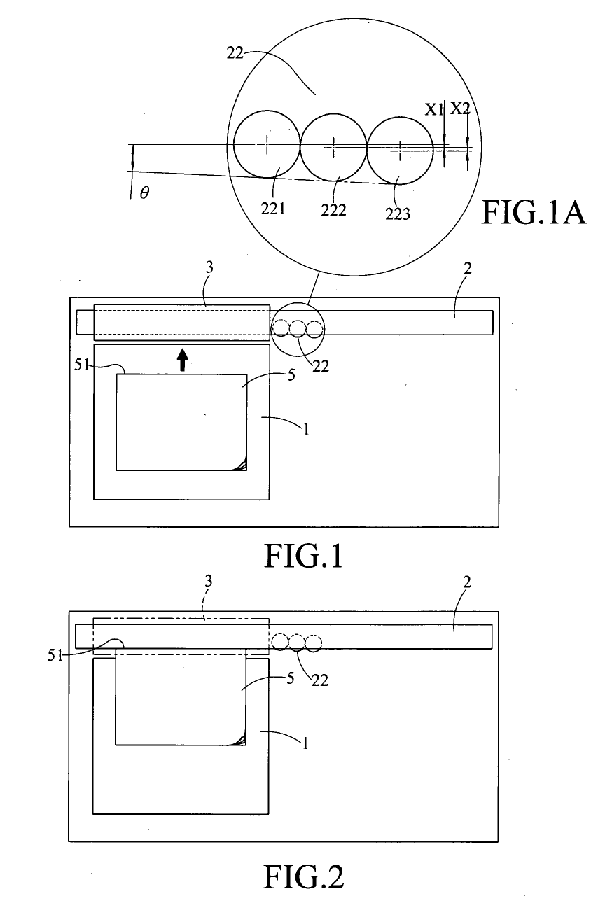

As shown in FIGS. 1˜4, an integrated hard cover production method and device contains a moving belt 1, a stop plate 2, and a translating device 3. “Pillows” of a curvature of a spine (i.e folded back portion) of a plurality of sheets can be flattened by steps as following:

1. a moving belt 1 feeds a stop plate 2 with a plurality of sheets 5; 2. the stop plate 2 stops and aligns a spine 51 of the plurality of sheets 5; 3. a translating device 3 grips the plurality of sheets firmly and moves the plurality of sheets transversely to a right side; 4. the spine 51 of the plurality of sheets 5 passes forming rollers 22 obliquely arranged along a front side of the stop plate 2; the forming rollers roll over and flatten the spine 51 once for all; 5. the plurality of sheets 5 are released from the translating device 3.

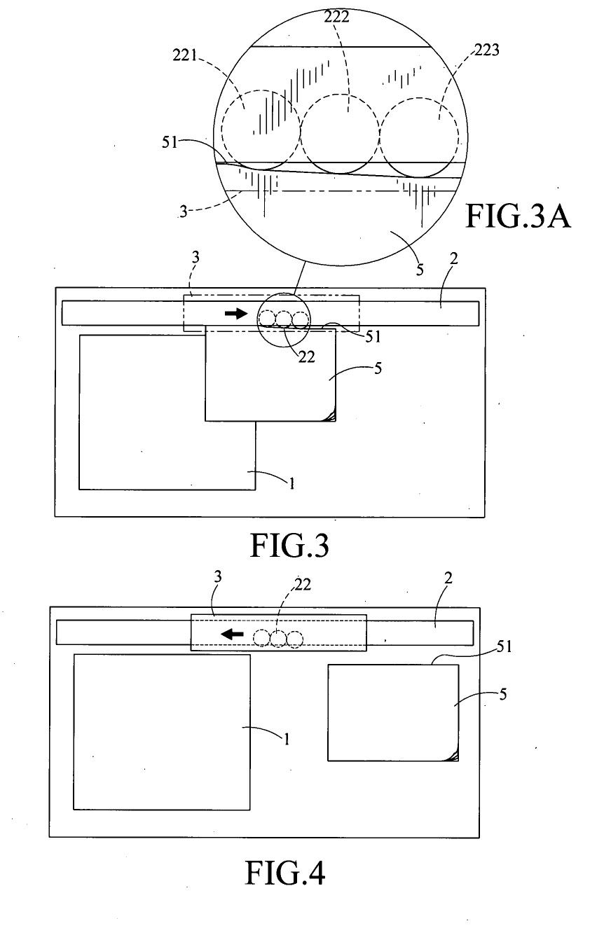

The step 1 is shown in FIG. 1, the plurality of sheets 5 is moved horizontally from a first end (i.e. a front end) of the moving belt 1 to a second end (i.e. a rear end) of the moving belt I promptly. The step 2 is shown in FIG. 2, the plurality of sheets 5 fit flush against the stop plate 2, the spine 51 resists against the stop plate 2. The step 3 is shown in FIG. 3, after the translating device grips the plurality of sheets 5, which is further moved transversely toward the right side (as shown in FIG. 3). The step 4 is shown in FIG. 4, after the plurality of sheets 5 is released, the translating device 3 promptly returns to an original position; the plurality of sheets 5 is fallen to a bottom plate of the frame 10 like a free falling body.

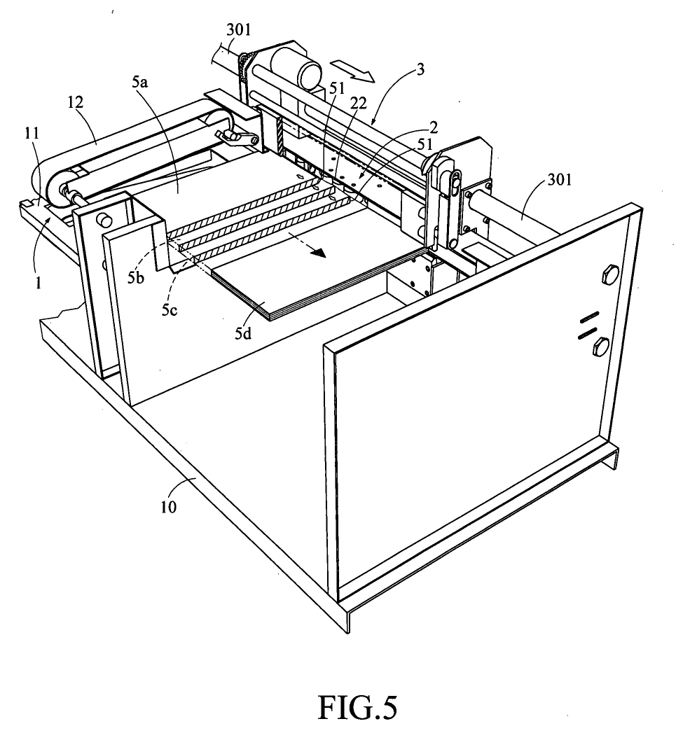

As shown in FIGS. 1A, 3A, the forming rollers 22 consists of a number of rollers 221,222,223 arrayed obliquely in a line side by side in order, and each subsequent roller is separated from a precedent roller at an equal distance. Thereby, the distance between a center of a first roller 221 and a center of a second roller 222 designated as X1 is identical to the distance between the center of the second roller 222 and a center of a third roller 223 designated as of the rollers 221,222,223 slid outward being incremented at equal intervals exposed out of a first side of the stop plate 2 and oriented in an inclined direction at an oblique angle θ. Therefore, the translate device 3 grips the plurality of sheets 5 and moves transversely toward the right side as numerals 5a˜5d shown in FIG. 5. As shown in FIG. 3A, the spine 51 of the plurality of sheets 5 is first encountered the first roller 221, by which the spine 51 of the plurality of sheets is less flattened, and then encountered the second roller 222, by which the spine 51 is more flattened, finally encountered the third roller 223, by which the spine 51 is overall flattened. Therefore, the spine 51 can be flattened by moving the plurality of sheets 5 transversely once for all. However, a set of forming rollers is not limited to three rollers, but more than three rollers can also be used. But the rollers must be arrayed one by one in order in an inclined direction, and an equal distance must be kept between each two adjacent rollers. And slide out sections of the rollers slid outward exposed out from a first side (i.e. a front side) of the stop plate 2.

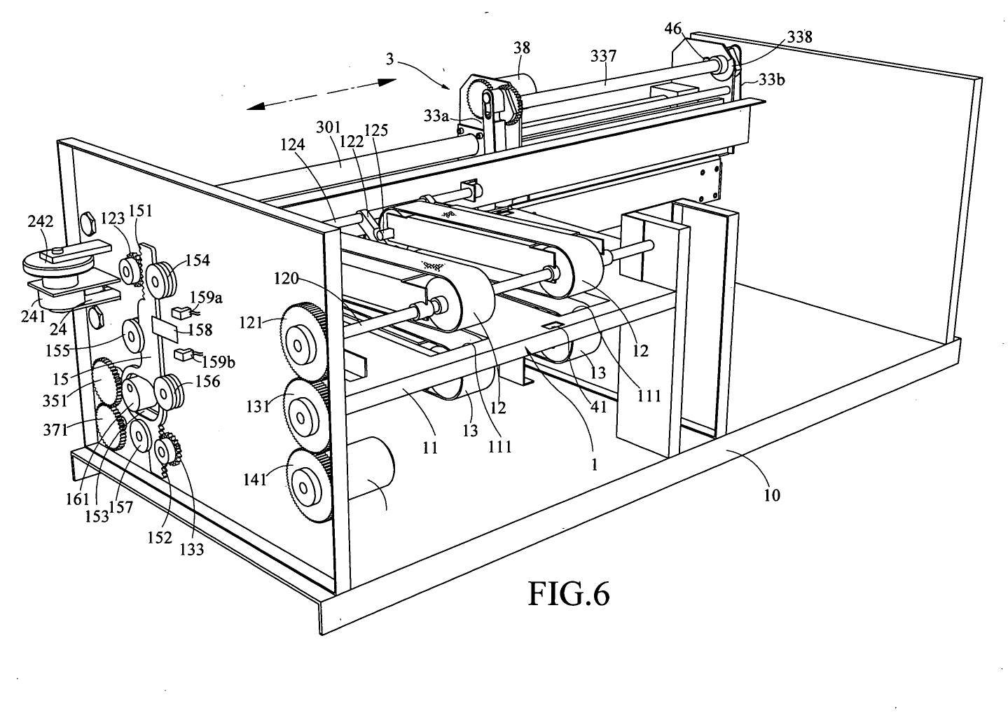

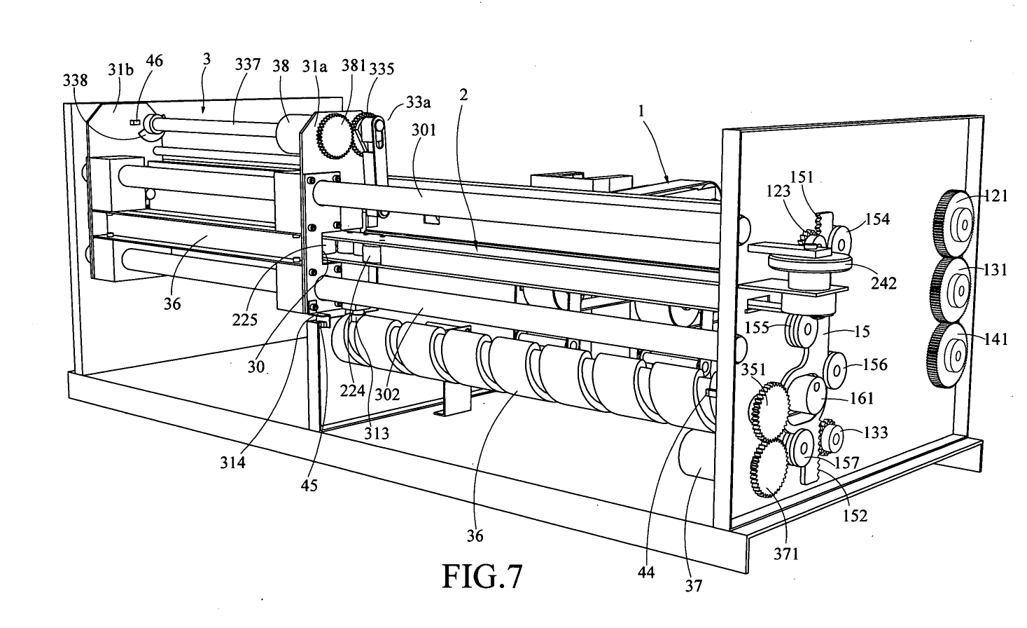

As shown in FIGS. 6, 8 and 9, the moving belt 1 contains a support plate 11 has a rectangular groove 111, an upper/a lower moving belts 12,13 are corresponding to each other and installed above/below the groove 111. The upper/lower moving belts 12, 13 can be open/close relative to the groove 111. The moving belts 12,13 stretch between a wheel with an axle 120 at the first end (i.e. the front end) and a wheel with an axle 130 at the second end (i.e. the rear end). The axles 120, 130 of the upper/lower moving belts 12,13 can be rotated by gears 121,131 respectively, gears 121, 131 are engaged with each other at left ends of the axles 120,130. The gear 131 is engaged with the gear 123, and the gear 131 is further engaged with a gear 141 and driven by the gear 123, and the gear 131 is further engaged with a gear 141 and driven by the gear 141 of a motor 14 fixed to a left side plate of the frame 10. Moreover, the plurality of sheets 5 located between the upper/lower moving belts 12,13 can be moved horizontally to the second end (i.e. the rear end), until the plurality of sheets 5 fit flush against the stop plate 2.

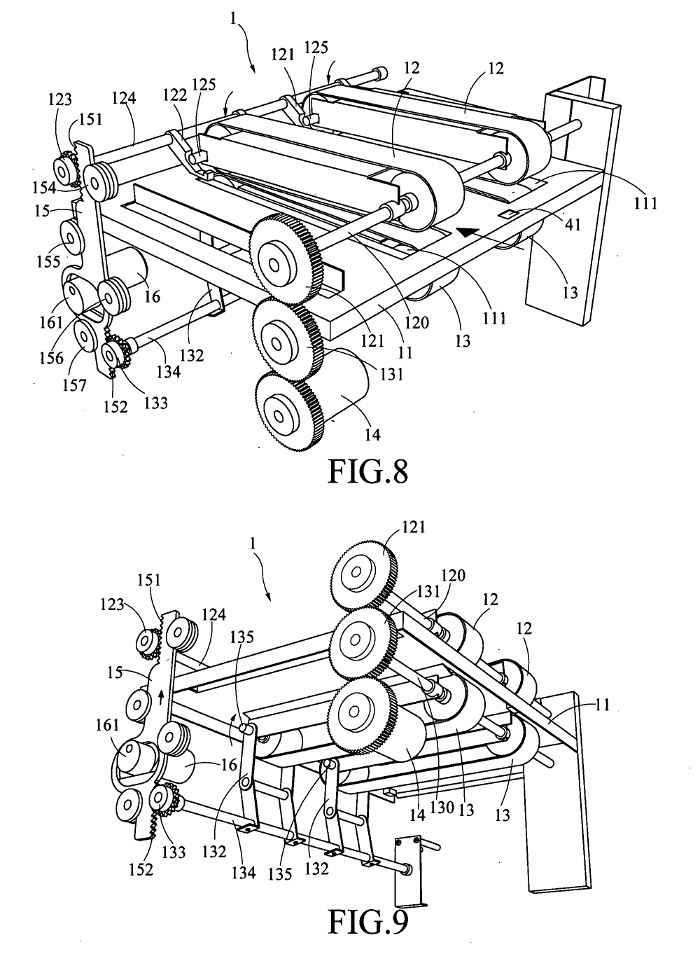

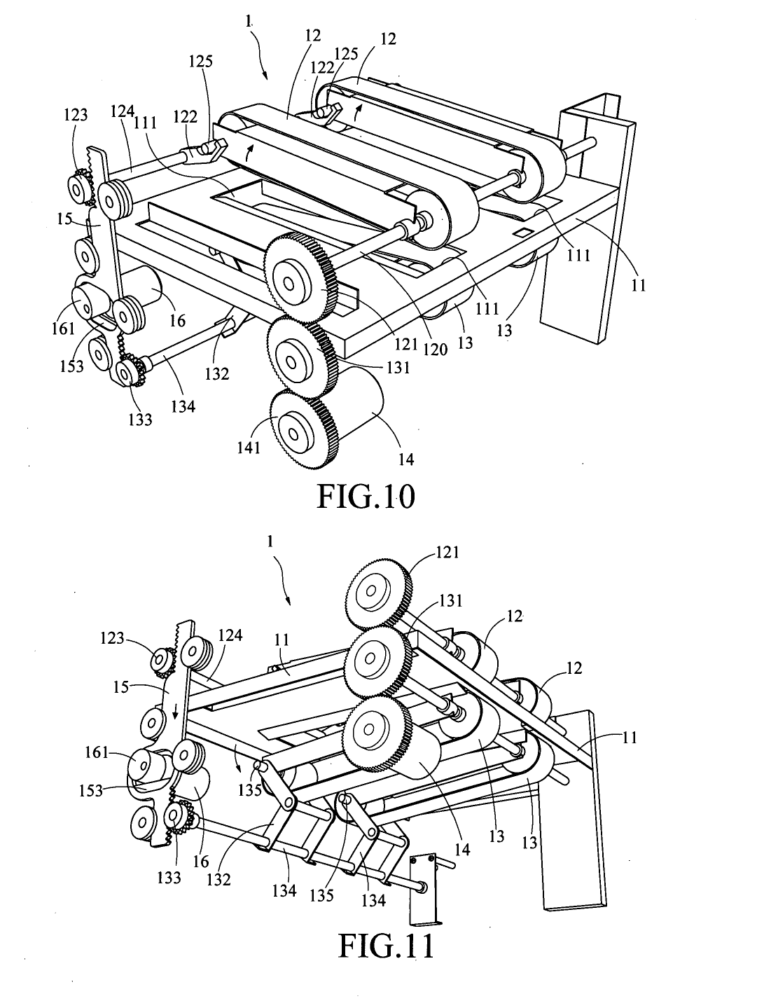

Axles 125, 135 of the moving belts 12,13 can be elevated/descent by a lever 15, which is driven by a motor 16 also fixed to the left side plate of the frame 10, thereby, the plurality of sheets 5 can be gripped or released. The lever 15 is reciprocally moved to elevate or descend, as an eccentric block 161 of the motor 16 moves around within a surrounded oval-shaped groove 153. To define the vertical movements of the lever 15, four positioning rollers 154˜157 arranged in a zigzag pattern along the lever 15 are applied to orient the lever in a normal position. Each of the positioning rollers 154˜157 has a central groove formed on a rim to couple with the lever 15 therein further the lever 15 is elevated/descent through them. Both top and bottom ends of the lever 15 moves vertically along tooth bars 151,152, where tooth bars engaged with the gears 123,133 at left ends of axles 124,134 respectively, Because in engagement, each of tooth bars divided into a number of teeth, thereby the gears 123,133 can be rotated in clockwise/counterclockwise directions to elevate/descend the axles 124,134. For example, as shown in FIG. 9, when the gear 133 located on a top portion of the tooth bar 152 in accordance with tooth engagement motion, a link 132 acts as an upstanding lift portion to raise the lower moving belt 13; while in FIG. 11, the gear 133 located on a bottom portion of the tooth bar 152, the link 132 acts as a bent backward portion to lower the lower moving belt 13. The upper moving belt 12 raised/lowered by a rocker 122 connected to the axle 124. The gear 123 at a left end of the axle 124 engaged with the tooth bar 151, as shown in FIG. 10, when the gear 123 located on a bottom portion of the tooth bar 151, the rocker 122 connected between the axle 124 and the upper moving belt 12 is raised to lift the upper moving belt 12. As shown in FIG. 8, when the gear 123 on a top portion of the tooth bar 151, the rocker 122 is lowered to lower the upper moving belt 12. Thereby, the upper/lower moving belts 12,13 are open/close to grip/release the plurality of sheets 5 related to the groove 111 as shown in FIGS. 10-11 and 8-9. When the plurality of sheets 5 is gripped firmly between the upper/lower moving belts 12,13, the plurality of sheets 5 can be moved horizontally from the front end to the rear end of the moving belt 1. After that, when the plurality of sheets is released from the moving belt 1, the translating device 3 can move the plurality of sheets 5 toward the right side of the frame 10. As mentioned above, a vertical displacement of the lever 15 can be controlled either by a programmable logic controller (PLC), or as shown in FIG. 6, two corresponding sensors 159a, 159b on the left side plate of the frame 10 are in coordination with a sensor 158 coupled on the lever 15 in the midst of the two corresponding sensors 159a,159b to control the lever 15.

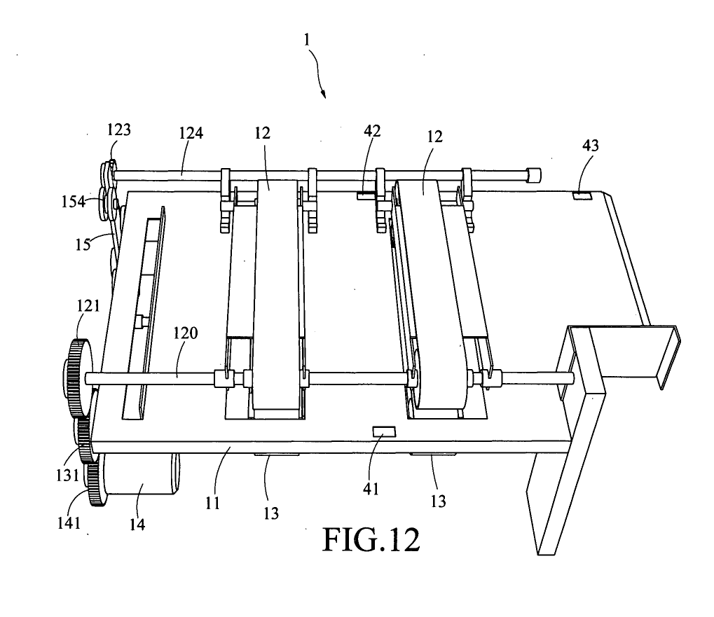

As shown in FIG. 12, a first end of the support plate 11 is sensor-equipped, where a sensor 41 sensing the plurality of sheets input is installed thereon, a second end of the support plate is also sensor-equipped, where a sensor 42 sensing the plurality of sheets output is installed thereon. While a sensor 43 sensing the plurality of sheets refill is installed near a right end of the frame 10. The sensor 41 sensing the plurality of sheets input is used to start rotating the motors 14,16. The sensor 42 sensing the plurality of sheets output is used to stop rotating the motors 14,16, and then starts rotating a motor 38 to activate the upper clamping jaw 34. The sensor 43 sensing the plurality of sheets refills is used to re-set the sensors 41,42 for feeding the stop plate 2 with a subsequent plurality of sheets 5, after a precedent plurality of sheets 5 is moved transversely through the frame 10.

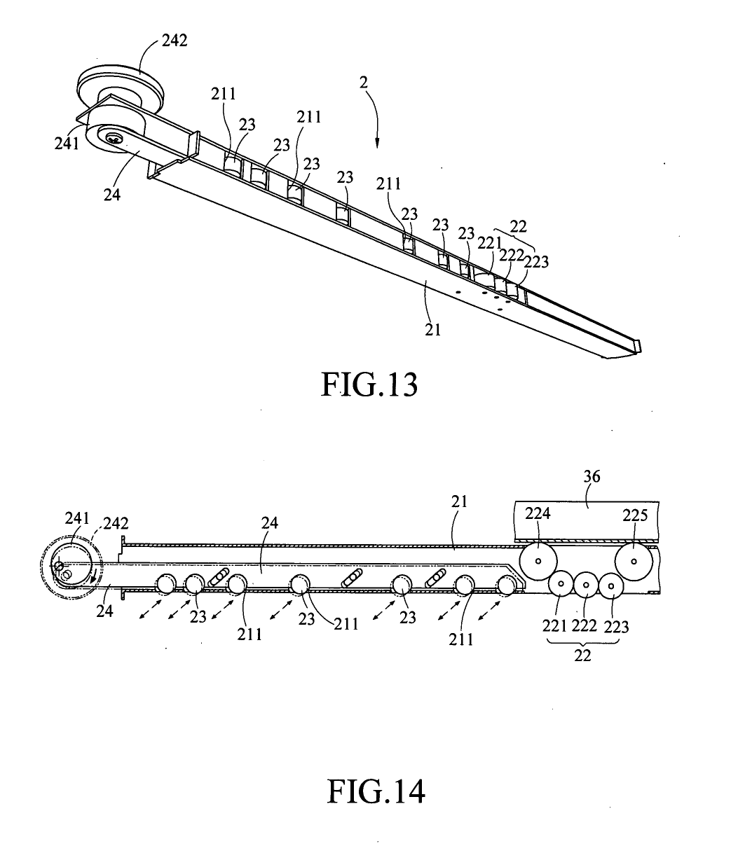

As shown in FIGS. 13, 14, the stop plate 2 is mainly composed of a glide slider 21. The forming rollers 22 consists of a number of rollers 221,222,223 arrayed obliquely in a line side by side in order with equal distance between each two adjacent rollers, of which slide out sections slid outward with equal distance in between along a first side (i.e. a front side) of the glide slider 21, oriented at an oblique angle θ. Thereby, the spine 51 passed through the rollers 221,222,223 can be flattened once for all. Moreover, both left and right sides of the forming rollers 22 are added with positioning rollers 224,225, which are used to resist against and support an U-shaped stopper 36.

Furthermore, a link 24 inside the glide slider 21 can be moved to and fro, a number of stopping rollers 23 axially arrayed in a line along the link 24, each of the stopping rollers 23 corresponding to a space 211 of the glide slider 21 has slide out sections a little slid outward from the space 211. A left end of the link 24 extended out of the glide slider 21 connects to an eccentric wheel 241, which is coaxially coupled to a knob 242. After rotating the knob 242, the link 24 can be brought to move to and fro inside the glide slider, and slide out sections a little slid outward from the space 211 can be further adjusted. As shown in FIG. 14, when the knob 242 is rotated in clockwise direction to a leftmost portion (where indicated by a circle in FIG. 14), the slide out sections of the stopping rollers 23 are slid outward utmost oriented in an oblique direction as depicted in dashed line; when the knob 242 is rotated in counterclockwise direction to a rightmost portion, the slide out sections of the stopping rollers are retracted utmost as depicted in solid line.

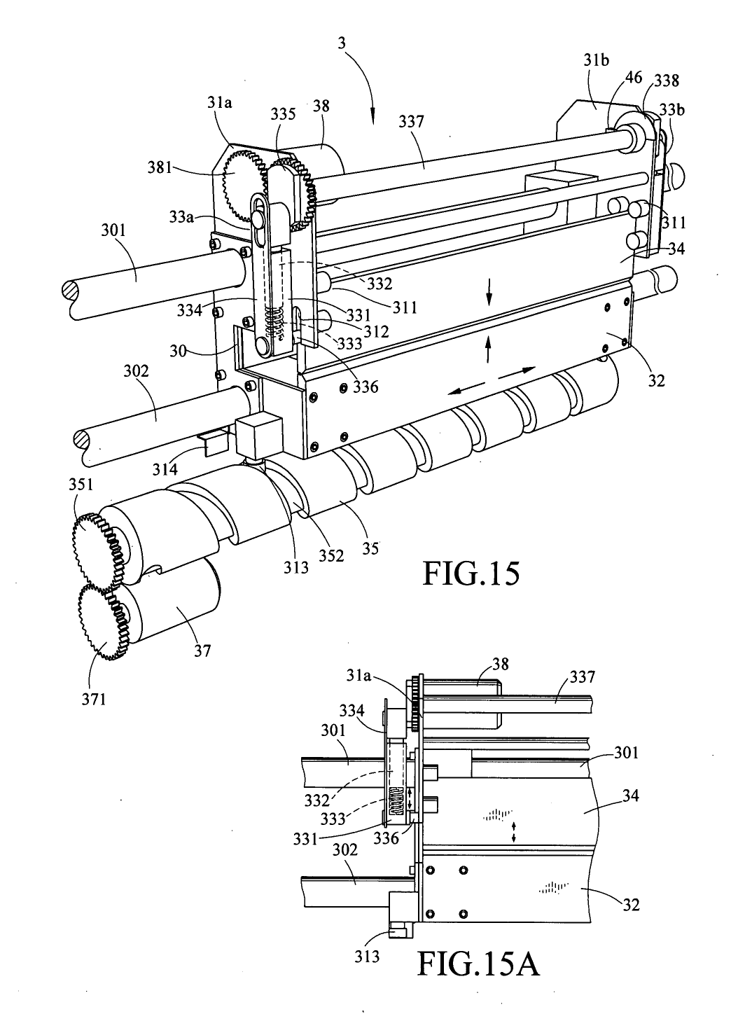

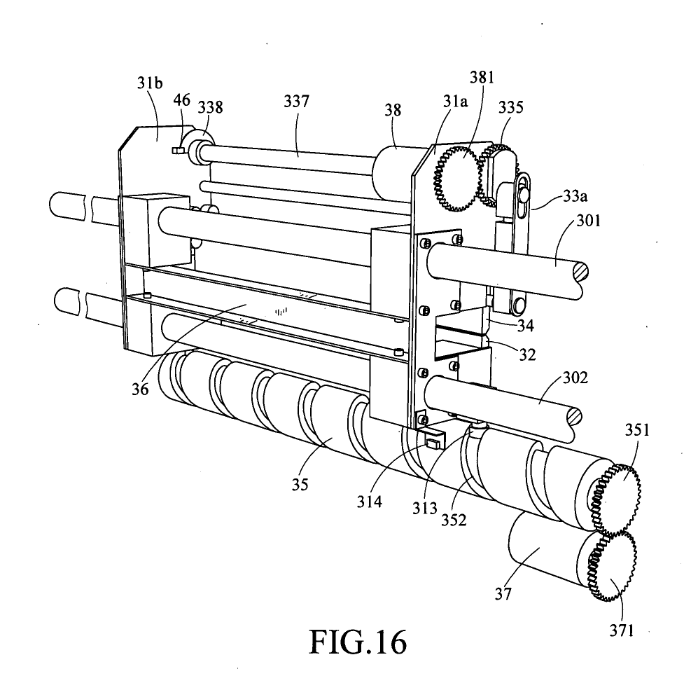

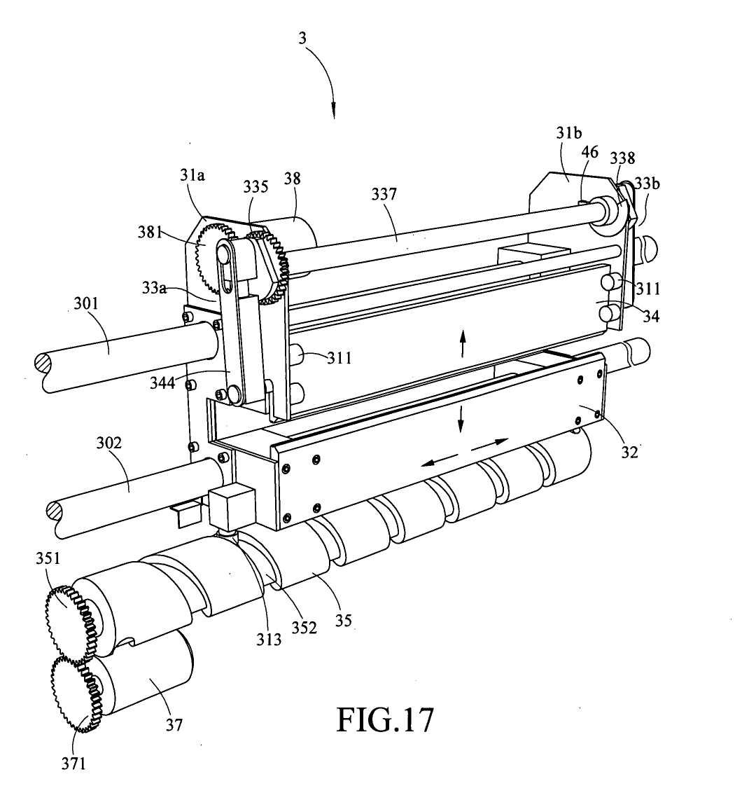

As shown in FIGS. 15˜17, the translating device 3 contains sliding shafts 301,302 transversely installed inside the frame 10 in parallel, two side plates 31a,31b fit over the sliding shafts 301,302 are formed with opened grooves 30 for receiving the stop plate 2 fit through. A lower clamping jaw 32 is installed between the side plates 31a,31b. Two tappets 33a, 33b are installed outside the side plates 31a, 31b respectively, an upper clamping jaw 34 moved by the tappets 33a,33b can move upward and downward to grip the plurality of sheets 5 firmly in coordination with the lower clamping jaw 32. A worm 35 installed below the sliding shafts 301,302 driven by a motor 351 can move the side plates 31a,31b along the sliding shafts 301,302.

A first tappets 33a is composed of a primary shaft 331 connected to the upper clamping jaw 34, a secondary shaft 332 is movably inserted into the primary shaft 331, an expansion spring 333 loaded within the primary shaft 331 resists against the secondary shaft 332, and a movable plate 334 is connected between the primary and secondary shafts 331,332. A top end of the secondary shaft 332 is mounted in an eccentric to a gear 335, which is driven by a gear 381 of a motor 38. A sensor-equipped revolving shaft 337 (the sensor is designated numeral 338) is connected between the gear 335 and a second tappet 33b, which has the same configuration as the first tappet 33a has. Thereby, the upper clamping jaw 34 can be moved upward and downward to grip firmly the plurality of sheets 5 in coordination with the lower clamping jaw 32 simultaneously. As shown in FIGS. 15 and 15A, the expansion spring 333 will be depressed further exerts a force, which is a derivation of an elastic force of the expansion spring 333 from depression, to grip the plurality of sheets firmly. By means of the expansion spring 333, the upper/lower clamping jaws can be used to grip the plurality of sheets 5 contains more or less pages.

Furthermore, each set of rollers 311 has two pairs of rollers in parallel with each other installed inside the side plates 31a, 31b respectively. Thereby, the upper clamping jaw 34 can be guided to elevate/descend within both two pairs of rollers 311 inside both side plates 31a, 31b. U-shaped grooves 312 formed through the side plates 31a, 31b can be used to confine vertical displacements of a shaft 336 connected between the primary shaft 331 and the upper clamping jaw 34.

Next, a bottom end of the side plate 31 is extended out a roller 313 and a sensing kit 314 separately. The roller 313 is extended to a guide groove 312. Two sensors 44,45 coupled to both left and right ends of the worm 35 respectively, each sensor 44 or 45 is activated by a signal, when the plurality of sheets passed by to obstruct the sensor 44,45, which is therefore activated, in turn, the responsive sensing kit 314 is triggered by the sensor 44 or 45 to stop a motor 37. Thereby, the translating device 3 can move to and fro for gripping or releasing the plurality of sheets 5. While the motor 37 stops to rotate in a clockwise/counterclockwise direction.

Next, a responsive sensor 46 coupled on the side plate 31b, when a sensor 338 coupled on the revolving shaft 337 is activated, in turn, the sensor 46 is triggered to define a vertical displacement of the upper clamping jaw 34 moved upward and downward.

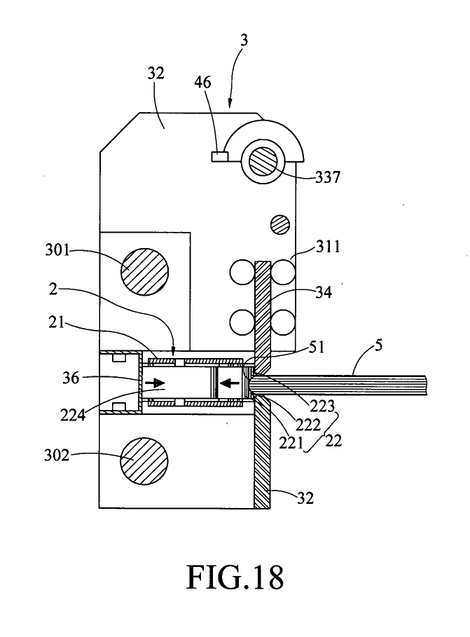

As shown in FIG. 18, a U-shaped stopper 36 is installed between the side plates 31a, 31b of the translating device 3. The U-shaped stopper 36 is corresponding to two positioning rollers 224,225 of the stop plate 2 (as shown in FIG. 14), and the positioning rollers 224, 225 resist against the U-shaped stopper 36. Thereby, the movable translating device 3 is not in contact with the stop plate 2 to avoid frictions from happening between the translating device 3 and the stop plate 2. Where when the plurality of sheets 5 is flush against the forming rollers 22 may exert a force toward the set of rollers 22 is already reduced, (as two opposite arrows shown in FIG. 18) The glide slider 21 can be further avoided from being deformed due to insufficient rigidity.

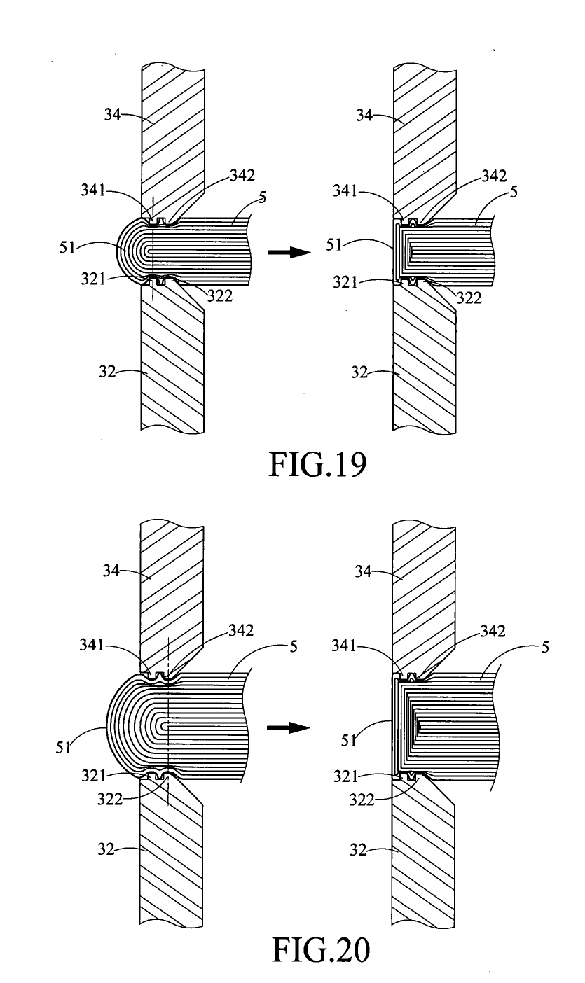

As shown in FIGS. 19˜20, a top end of the lower clamping jaw 32 has a rear rib 321, a front rib 322. A bottom end of the upper clamping jaw 34 has a rear rib 341, a front rib 342. Since the ribs 321, 322 in pair are corresponding to the ribs 341,342 in pair, the rear fronts 321,341 of the upper/lower clamping jaws 32,34 are preferable for clamping the plurality of sheets 5 contents of a few pages (i.e up to 20 pages) with a stable securing effect (as shown in FIG. 19). While the front ribs 322,342 of the upper/lower clamping jaws 32, 34 are preferable for clamping the plurality of sheets 5 contents of a lot of pages (i.e. up to 100 pages) with a stable securing effect.

### ADVANTAGES OF EMBODIMENTS OF THE INVENTION

Advantages can be achieved by embodiments of the present invention as following:

1. Rollers 221, 222, 223 of a set of forming rollers 22 are arrayed side by side in order further a little obliquely along a front side of a stop plate 2. Thereby, a curvature of a spine (i.e. folded back portion) can be flattened gradually when the plurality of sheets 5 is flush against the stop plate 2, and a translating device 3 is only required to move transversely once for all. A workload of the forming rollers 22 can be reduced; a life-cycle of the system can be prolonged.

2. Each of the stopping rollers 23 has a slide out section slid outward of the front side of a glide slider, The slide out sections slid outward can be adjusted to flatten the spine, when the plurality of sheets 5 contains only a few pages (i. e. up to twenty pages), the slide out sections must be a larger section, otherwise the spine may be formed with wrinkles. Only when the plurality of sheets 5 contains more pages (i.e. up to one hundred pages), the slide out sections can be a smaller section, or the spine is insufficient to meet the slide out sections.

3. A sensor 41 sensing the plurality of sheets input starts the upper and lower moving belts 12,13 moving the plurality of sheets 5 to the stop plate 2, until the spine passed over a sensor 42 sensing the plurality of sheets output. A translating device 3 is simultaneously moved toward a left end of the frame, where the translating device 3 is ready to grip the plurality of sheets 5. When the sensor 44 coupled on a left end of the worm 35 detects the sensing kit 314 coupled on a bottom of the side plate 31a, the translating device 3 stops moving. At the same time, the upper clamping jaw 34 is lowered to grip the plurality of sheets 5, until the sensor 46 coupled on the side plate 31b detects the sensor 338 coupled on the revolving shaft 337, the upper clamping jaw 34 stops lowering. And the upper/lower moving belts 12,13 of the moving belt 1 is open, the translating device 3 transversely moves the plurality of sheets 5 toward the set of forming rollers 22. After the plurality of sheets pass over a sensor sensing the plurality refill 43 coupled on the support plate 11, the upper/lower moving belts 12,13 is close to grip and move another plurality of sheets 5 to the stop plate 2. A sensor 45 coupled to a right end of the worm 35 also detects the sensor 314 coupled to the bottom of the left side plate 31a, the translating device 3 stops moving, and the upper clamping jaw 34 releases the plurality of sheets with flattened spine. The upper clamping jaw 34 moving upward which is regulated When the sensor 46 coupled on the side plate 31b detects the sensor-equipped revolving shaft 337 twice, where the sensor 338 coupled on the revolving shaft 337 is semi-circular in shape, by which the revolving shaft 337 must be rotated to and fro two times let the sensor 338 passes over the sensor 46, and then the sensor 338 can be detected twice. Thereby, the upper clamping jaw 34 stops moving upward. As a result, a streamlined process of flattening the spine can be realized.

4. The stop plate 2 mainly consists of a glide slider 21, when the spine 51 is flush against the set of forming rollers 22, the translating device 3 can reduce a single sided pressure in reverse direction by the U-shaped stopper 36 resisting against the positioning rollers 224, 225. Thereby the glide slider 21 can be avoided from deformation due to its rigidity, if any, is insufficient.

5. A top end of the lower clamping jaw 32 has a rear rib 321, a front rib 322; a bottom end of the upper clamping jaw 34 has a rear rib 341, a front rib 342; when gripping the plurality of sheets 5 contains less pages, both rear ribs 321,341 can grip the spine with smaller curvature. When gripping the plurality of sheets contains more pages, the front ribs 322,342 can grip the spine with larger curvature, thereby, the plurality of sheets can be gripped firmly by the upper/lower clamping jaws 32,34 either the plurality of sheets contains more pages or contains less pages.

What is claim claimed:

1. An integrated hardcover production method and device comprising steps: 1. a moving belt (1) feeds a stop plate (2) with a plurality of sheets (5); 2. the stop plate (2) simultaneously stops and aligns a spine (51) of the plurality of sheets (5); 3. a translating device (3) grips the plurality of sheets firmly and moves the plurality of sheets transversely to a right side; 4. the spine (51) of the plurality of sheets (5) passes through a set of forming rollers (22) obliquely arranged along a front side of the stop plate (2); the forming rollers roll over and flatten the spine (51) once for all; 5. the plurality of sheets (5) are released from the translating device (3).

2. An integrated hardcover production method and device comprising: a moving belt (1) installed inside a frame (10) horizontally moves a plurality of sheets (5) from a first end (i.e. a front end) to a second end (i.e. a rear end) thereof; a stop plate (2) installed to the second end of the moving belt (1) simultaneously stops and aligns a spine (51) of the plurality of sheets (5); a set of forming rollers (22) are obliquely installed along a first side (i.e. a front side) of the stop plate (2) arrayed in an oblique direction from left to right and gradually convex outward (i.e. from the second end to the first end); a translating device (3) moves transversely along the stop plate (2) in the frame (10) to and fro, thereby the plurality of sheets (5) gripped by the translating device (3), the spine (51) flattened by passing through the set of forming rollers (22).

3. An integrated hardcover production method and device as claim 2 claimed wherein the moving belt (1) includes a support plate (11) has a groove (111), an upper moving belt (12) and a lower moving belt (13) mounted above/below the groove (111) in pair, where the upper belt (12) is corresponding to the lower belt (13); axles (120,130) of the moving belts (12,13) have driven gears (121,131) engaged with each other at left ends of the axles (120,130), a motor (14) fixed to a left side plate of the frame (10) has a gear (141) drives the gears (121,131) to rotate, whereby the upper/lower moving belts (12,13) move horizontally the plurality of sheets (5) inward (i.e. from the front end to the second end), axles (125,135) of the moving belts (12,13) drive a lever (15) to elevate/descend by a motor (16) fixed to the left side plate of the frame (10), thereby the plurality of sheets (5) can be gripped or released.

4. An integrated hardcover production method and device as claim 3 claimed wherein an eccentric block (161) of the motor (16) drives the lever (15) moving reciprocally to elevate/descend along teeth bars (151,152) formed at top/bottom ends of the lever (15) to drive gears (123,133) rotating in clockwise/counterclockwise direction, the gears (123,133) installed at left ends of the axles (124, 134) respectively; the axle (124) coupled to a rocker (122), and the axle (134) coupled to a link (132) respectively, the rocker (122) and the link (132) drive the axles (125,135) of the upper/lower moving belts (12,13) to open/close the moving belt (1) simultaneously.

5. An integrated hardcover production method and device as claim 3 claimed wherein a sensor (41) for sensing the plurality of sheets (5) input installed at a first end (i.e. a front end) of the support plate (11), a sensor (42) for sensing the plurality of sheets (5) output installed at a second end (i.e. a rear end) of the support plate (11), a sensor (43) for sensing the plurality of sheets (5) refills installed near a right side plate of the frame (10).

6. An integrated hardcover production method and device as claim 2 claimed wherein the stop plate (2) mainly consists of a glide slider (21), the forming rollers (22) contains rollers (221,222,223) arrayed side by side in order with slide out section slid outward from a first side of the glide slider (21); further two positioning rollers (224,225) retracted rearward related to the rollers (221˜223) and projected out of a second side of the glide slider (21) to resist against a U-shaped stopper (36).

7. An integrated hardcover production method and device as claim 6 claimed wherein a link (24) inserted in the glide slider (21), a number of stopping rollers (23) axially arrayed in alignment with one another along the link (24), each of the stopping rollers (23) has a slide out section a little slid outward from a space (211) of the glide slider (21), a left end of the link (24) extended out of the glide slider (21) is coupled to an eccentric wheel (241), which is coaxially coupled to a knob (242), which is rotated to activate the link (24) and to adjust a slide out section of the stopping rollers (23) slid outward from the space (211).

8. An integrated hardcover production method and device as claim 2 claimed wherein the translating device (3) includes an upper sliding shaft (301) and a lower sliding shaft (302) transversely installed inside the frame (10) in parallel with each other, two side plates (31a,31b) fit over the sliding shafts (301,302) formed with opened grooves (30) for passing through the stop plate (2) to and fro; a lower clamping jaw (32) installed between the side plates (31a,31b), two tappets (33a,33b) installed outside the two side plates (31a,31b) respectively, an upper clamping jaw (34) moved by the tappets (33a,33b) moves upward and downward in coordination with the lower clamping jaw (32) to grip/release the plurality of sheets (5); and a worm (35) installed below the sliding shafts (301,302) is driven by a motor (351) to drive the side plates (31a,31b) moving along the sliding shafts (301,302).

9. An integrated hardcover production method and device as claim 8 claimed wherein the tappet (33a) consists of a primary shaft (331) connected to the upper clamping jaw (34), a secondary shaft (332) inserted into the primary shaft (331), an expansion spring (333) loaded within the primary shaft (331) resists against the secondary shaft (332), and a movable plate (334) connected between the primary shaft (331) and the secondary shaft (332); a top end of the secondary shaft (332) is mounted in an eccentric to a gear (335), which is further connected to the tappet (33b) by a sensor-equipped revolving shaft (337)(the sensor is designated a numeral (338)), the tappet (33b) has the same configuration as the tappet (33a) has, the upper clamping jaw (34) moved by the tappets (33a, 33b) can be displaced upward and downward to grip the plurality of sheets (5) in coordination with the lower clamping jaw (32), where the upper clamping jaw (34) is connected to the tappet (33a) by a shaft (336), the plurality of sheets (5) is gripped between the upper/lower clamping jaws (34,32), the expansion spring (333) will be depressed further exerts a force, which is a derivation of an elastic force of the expansion spring (333) from depression, to grip the plurality of sheets firmly.

10. An integrated hardcover production method and device as claim 9 claimed wherein each inner wall of the side plates (31a, 31b) are equipped with two pairs of rollers are correspondingly in parallel with each other, thereby the upper clamping jaw (34) can be guided to elevate/descend through the rollers; lower portions of the side plates (31a,31b) have U-shaped grooves (312) to confine a vertical displacement of the shaft (336), which is connected between the upper clamping jaw (34) and the tappet (33a).

11. An integrated hardcover production method and device as claim 9 claimed wherein a bottom end of the side plate (31a) is extended out with a sensing kit (314) and a roller (313), the roller (313) is further extended to a guide groove (352) of the worm (35), the translating device (3) moves to and fro as the plurality of sheets (5) is gripped or released, each of two sensors (44,45) coupled to both ends of the worm (35) is activated by a signal respectively, in turn, the sensing kit (314) is triggered to stop a motor (37).

12. An integrated hardcover production method and device as claim 9 claimed wherein the sensor (338) coupled to the revolving shaft (337) is activated, in turn, a sensor (46) coupled to the side plate (31b) is triggered to limit the upper clamping jaw (34) moving upward and downward confined within a limited distance.

13. An integrated hardcover production method and device as claim 8 claimed wherein a U-shaped stopper (36) transversely installed between the side plates (31a, 31b) of the translating device (3), the U-shaped stopper (36) is corresponding to the positioning rollers (224,225) of the stop plate (2); further the U-shaped stopper (36) is in contact with both rollers (224,225).

14. An integrated hardcover production method and device as claim 8 claimed wherein a top end of the bottom clamping jaw (32) has a front rib (322), a rear rib (321), a bottom end of the upper clamping jaw (34) has a front rib (342), a rear rib (341); the ribs (322,321) are corresponding to the ribs (342,341).
